(19) United States
(12) Patent Application Publication
(10) Pub. No.: US 2024/0249711 A1
(43) Pub. Date: Jul. 25, 2024

(54) AUDIO CANCELLATION

(71) Applicant: Nokia Technologies Oy, Espoo (FI)

(72) Inventors: Lasse Juhani LAAKSONEN, Tampere (FI); Antti Johannes Eronen, Tampere (FI); Arto Juhani Lehtiniemi, Tampere (FI)

(21) Appl. No.: 18/393,966

(22) Filed: Dec. 22, 2023

(30) Foreign Application Priority Data
Jan. 23, 2023 (EP) 23152802.7

(51) Int. Cl. G10K 11/175

(52) U.S. Cl. CPC G10K 11/175

(57) ABSTRACT

An apparatus comprising:
means for applying at least an audio cancellation process to captured ambient audio to create first user ambient audio;
means for providing to another apparatus at least first user ambient audio information to enable remote rendering of at least some of the first user ambient audio.

### TECHNOLOGICAL FIELD

Examples of the disclosure relate to audio cancellation.

### BACKGROUND

Active noise cancellation (ANC) estimates the noise that would reach a listener's ear and adapts the audio output signals to cancel that estimated noise. The noise can be estimated using a feed-forward approach that uses one or more noise signals measured using one or more exterior microphones on the same ear device and/or using a feed-back approach that uses one or more noise signals measured using one or more interior microphones of the same ear device.

It is possible to adapt active noise cancellation (ANC) which attempts to fully suppress exterior sounds and prevents them reaching a listener's ear, to achieve active audio cancellation which selectively suppresses exterior sounds and prevents some but not necessarily all exterior sounds reaching a listener's ear. This can prevent some exterior sounds reaching a user's ear while allowing other exterior sounds to ‘pass-through’ and reach the user's ear.

It is possible to adapt the active noise cancellation (ANC) which attempts to fully suppress exterior sounds and prevents them reaching a user's ear, to achieve active audio cancellation which selectively suppresses exterior sounds.

For example, an adjustable own voice mode can let a user change how much of their own voice passes through and reaches a user's ear.

For example, an adjustable transparency mode can let a user change how much exterior audio passes through to the user. This can allow a user switch from hearing no exterior sound to hearing exterior sound at a controlled level.

### BRIEF SUMMARY

According to various, but not necessarily all, examples there is provided an apparatus comprising:
means for applying at least an audio cancellation process to captured ambient audio to create first user ambient audio;
means for providing to another apparatus at least first user ambient audio information to enable remote rendering of at least some of the first user ambient audio.

In some but not necessarily all examples, the means for applying the audio cancellation process to the captured ambient audio to create first user ambient audio is configured to:
disambiguate audio sources in the captured ambient audio;
apply different cancellation processes to audio of different audio sources.

In some but not necessarily all examples, the first user ambient audio information comprises the captured ambient audio and data to enable remote reproduction and
rendering of at least some of the first user ambient audio
or
comprises the first user ambient audio.

In some but not necessarily all examples, the data is dependent on the audio cancellation process applied to the captured ambient audio to create the first user ambient audio.

In some but not necessarily all examples, the apparatus comprises:
means for applying a second audio cancellation process to the captured ambient audio to create remote user ambient audio for rendering to a remote user,
wherein the second audio cancellation process is different to a first audio cancellation process applied to the captured ambient audio to create the user ambient audio rendered to a first user and is configured to cancel audio in addition to that cancelled by the first audio cancellation process.

In some but not necessarily all examples, the apparatus is configured to perform the second audio cancellation process after the first audio cancellation process.

In some but not necessarily all examples, the apparatus is configured to provide to the another apparatus at least first user ambient audio information in a format to enable remote rendering of the first user ambient audio to a remote user, wherein the format has one of more of the following characteristics:
enables remote rendering as world-fixed audio;
enables remote rendering at a headset or speakers, at choice of a rendering apparatus;
enables remote rendering as a sound source that has a controlled location.

In some but not necessarily all examples, the apparatus is configured as a head-worn apparatus, an in-ear apparatus, an on-ear apparatus or an over-ear apparatus.

In some but not necessarily all examples, the apparatus comprises:
means for capturing ambient audio;
means for rendering, to a first user, the first user ambient audio;
means for rendering, to the first user, first user content.

In some but not necessarily all examples, the apparatus comprises:
means for providing to the another apparatus
at least the first user ambient audio information; and
first user content information;
to enable remote rendering of first user content and the first user ambient audio to a remote user. In some but not necessarily all examples, the apparatus is configured to communicate with a headset

In some but not necessarily all examples, the apparatus comprises: means for providing to the another apparatus voice audio, captured for a first user of the apparatus, to enable remote rendering of the voice audio and at least some of the first user ambient audio to a remote user.

According to various, but not necessarily all, examples there is provided a computer program comprising instructions that when executed by one or more processors causes:
applying a first audio cancellation process to captured ambient audio to create first user ambient audio;
means for providing to another apparatus
at least first user ambient audio information
to enable remote rendering of at least some of the first user ambient audio.

According to various, but not necessarily all, examples there is provided a method comprising:
applying a first audio cancellation process to captured ambient audio to create first user ambient audio;
means for providing to another apparatus
at least first user ambient audio information
to enable remote rendering of at least some of the first user ambient audio.

According to various, but not necessarily all, examples there is provided a system comprising:
means for capturing ambient audio
means for applying a first audio cancellation process to the ambient audio to create first user ambient audio;
means for rendering, to a first user, first user ambient audio;
means for rendering, to the first user, first user content;
means for providing to a remote user
at least first user ambient audio information
first user content information
to enable remote rendering of first user content and at least some of the first user ambient audio to the remote user.

According to various, but not necessarily all, examples there is provided examples as claimed in the appended claims.

While the above examples of the disclosure and optional features are described separately, it is to be understood that their provision in all possible combinations and permutations is contained within the disclosure. It is to be understood that various examples of the disclosure can comprise any or all of the features described in respect of other examples of the disclosure, and vice versa. Also, it is to be appreciated that any one or more or all of the features, in any combination, may be implemented by/comprised in/performable by an apparatus, a method, and/or computer program instructions as desired, and as appropriate.

### BRIEF DESCRIPTION

Some examples will now be described with reference to the accompanying drawings in which:

FIG. 1 shows an example of a system 10 operating to render locally 19 content 40 and ambient audio 32;

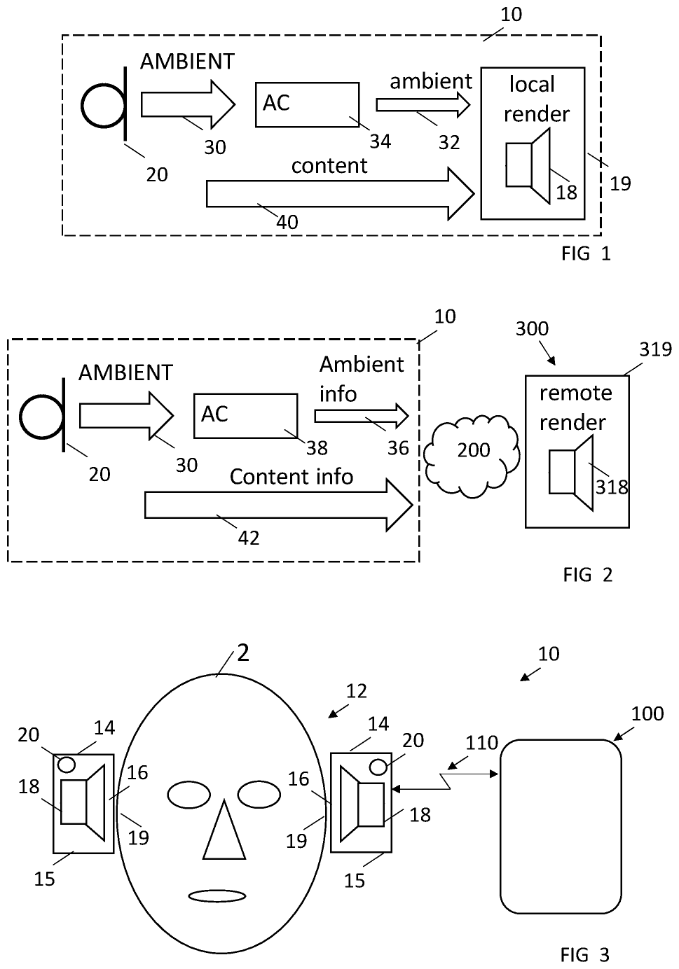

FIG. 2 shows an example of the system 10 operating to control 36, 42 remote rendering 319 of content and ambient audio that has a correspondence to the content 40 and ambient audio 32 rendered locally 19;

FIG. 3 shows an example of the system 10 configured as a head-worn apparatus 12 that communicates with a local apparatus 100 which communicates with a remote apparatus;

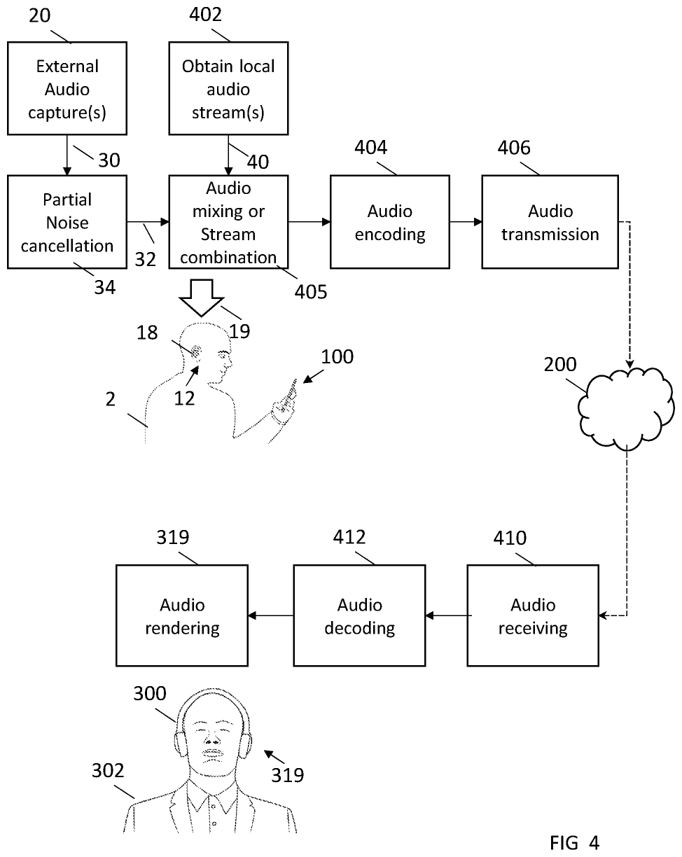

FIG. 4 illustrates an example of an operational process flow for the system 10 which achieves local rendering 19 to a local user 2 of content 40 and ambient audio 32 and remote rendering 319 to a remote user 302 of content and ambient audio that has a correspondence to the content 40 and ambient audio 32 rendered locally 19;

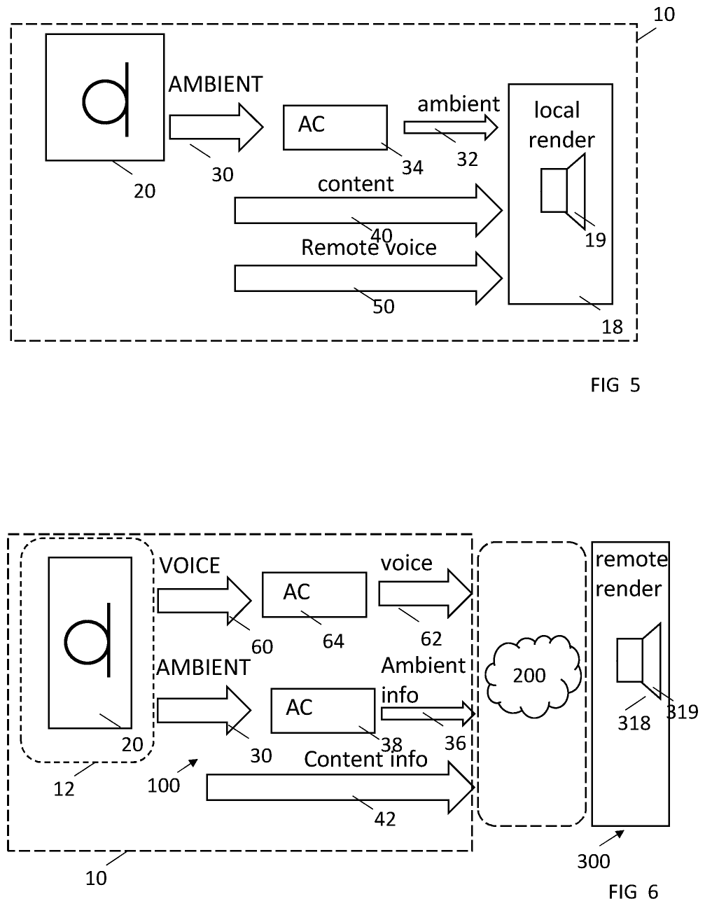

FIG. 5 shows an example of a system 10 operating to render locally 19 content 40, ambient audio 32 and voice audio 50 of a remote user 302;

FIG. 6 shows an example of the system 10 operating to control 36, 42, 62 remote rendering 319 of voice audio 60 of the local user 2 and also content and ambient audio that has a correspondence to the content 40 and ambient audio 32 rendered locally 19 to the local user 2;

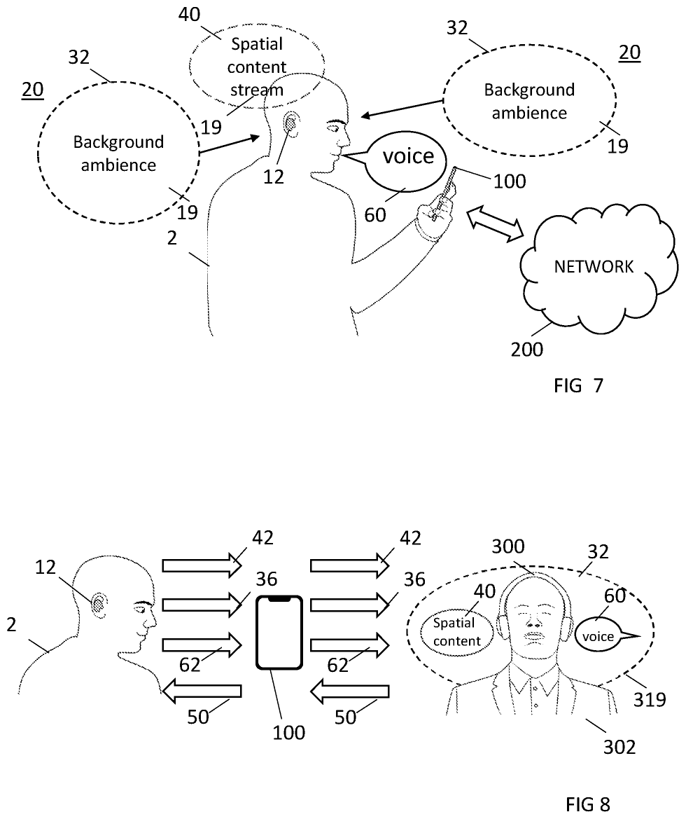

FIG. 7 shows an example of the system 10 in use to render locally 19 spatial audio content 40 and ambient audio 32 (and optionally voice audio 50 of a remote user 302);

FIG. 8 shows an example of the system 10 in use to cause remote rendering 319 of voice audio 60 of the local user 2 and also content and ambient audio that has a correspondence to the content 40 and ambient audio 32 rendered locally 19 to the local user 2;

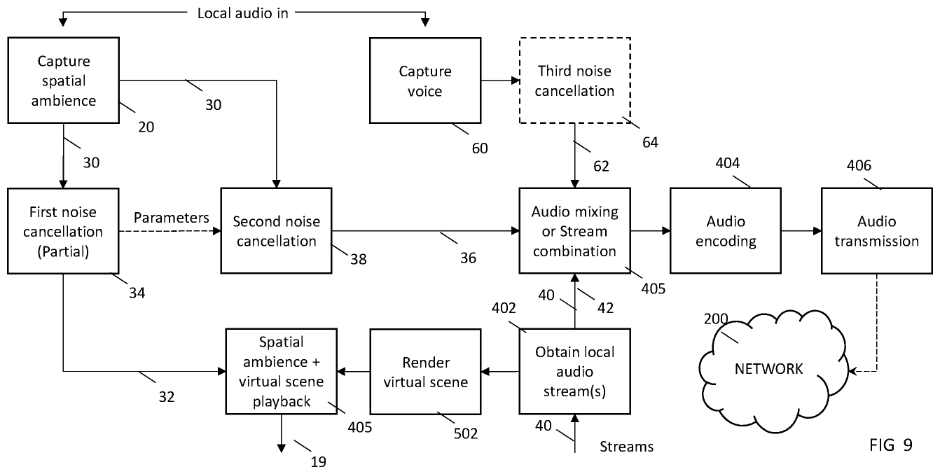

FIG. 9 illustrates an example of an operational process flow for the system 10 which achieves local rendering 19 to a local user 2 of voice audio 50 of the remote user 302 and also of content 40 and ambient audio 32, and achieves remote rendering 319 to a remote user 302 of voice audio 60 of the local user 2 also of content and ambient audio that has a correspondence to the content 40 and ambient audio 32 rendered locally 19 to the local user 2;

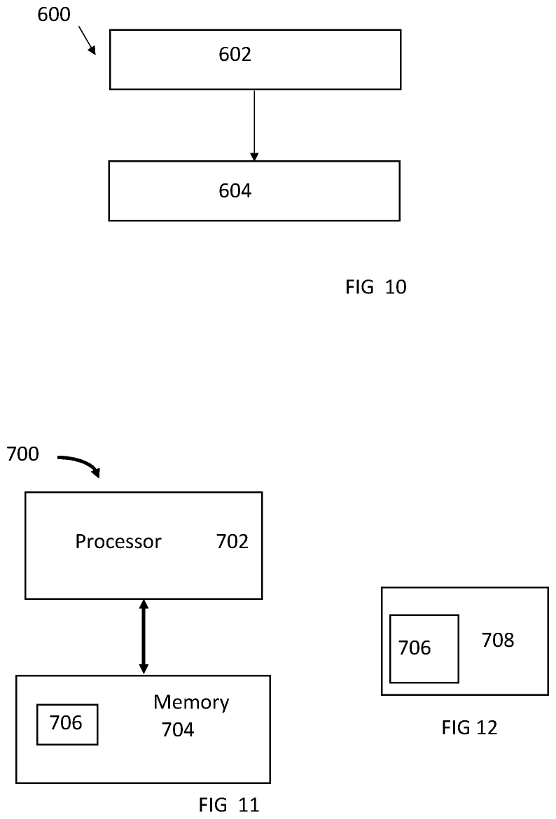

FIG. 10 shows an example of a method 600 operating to render locally content and ambient audio and control remote rendering of content and ambient audio that has a correspondence to the content and ambient audio rendered locally.

FIG. 11 shows an example of controller suitable for causing performance of the method 600 and for use by the system 10;

FIG. 12 shows an example of computer program 706 suitable for causing performance of the method 600.

The figures are not necessarily to scale. Certain features and views of the figures can be shown schematically or exaggerated in scale in the interest of clarity and conciseness. For example, the dimensions of some elements in the figures can be exaggerated relative to other elements to aid explication. Similar reference numerals are used in the figures to designate similar features. For clarity, all reference numerals are not necessarily displayed in all figures.

### Definitions

Apparatus is equipment for performance of a task. An apparatus can be a unitary apparatus that is equipment that is contained within a single housing. An apparatus can be a non-unitary apparatus that is not contained within a single housing, and may be contained within multiple housing that are physically or wirelessly interconnected.

Audio refers to sound audible to a human. The term audio is used irrespective of the format of sound, which can for example be pressure waves, an electrical signal that can be transduced to produce sound or information that can be used to render sound.

Render when applied to audio means producing sound or producing a format readily convertible to sound.

Audio cancellation refers to a removal of audio by electronic processing. This can be achieved, for example, using digital signal processing.

Capturing means recording to a format that can be subsequently used.

Ambient refers to immediate surroundings. Ambient audio refers to sound that is or could be heard by a person at a particular location. The source of the sound does not need to be proximal to the user but sound needs to reach the person.

User is a person using an apparatus.

Spatial audio describes the rendering of sound sources at different controllable directions relative to a listener.

### DETAILED DESCRIPTION

The following description relates to various examples of an apparatus comprising:
means for applying at least an audio cancellation process 34 to captured ambient audio 30 to create first user ambient audio 32; and
means for providing to another apparatus at least first user ambient audio information 36 to enable remote rendering of at least some of the first user ambient audio 32.

In some examples, the apparatus is a head-worn apparatus 12 and the other apparatus is a local apparatus 100. Remote rendering can occur at a remote apparatus 300.

In some examples, the apparatus is a local apparatus 100 and the other apparatus is a remote apparatus 300 where the remote rendering occurs.

In some examples, the apparatus is a head-worn apparatus 12 and the other apparatus is a remote apparatus 300 where the remote rendering occurs.

FIG. 1 illustrates an example of a system 10 for rendering audio to a local user 2 (not illustrated).

The system 10 comprises:
means 20 for capturing ambient audio 30
means for applying an audio cancellation process 34 to the captured ambient audio 30 to create first user ambient audio 32;
means 18 for rendering 19 first user ambient audio 32
means 18 for rendering 19 first user content 40.

FIG. 2 illustrates an example of the system 10 operating to cause or enable rendering of audio to a remote user (not illustrated).

The system 10 comprises:
means for providing to a remote apparatus 300 at least first user ambient audio information 36 and first user content information 42 to enable remote rendering 319 of the first user content 40 and at least some of the first user ambient audio 32.

In some examples, the system 10 enables remote rendering 319 of the first user ambient audio 32. That is the first user ambient audio 32 that is rendered locally 19 is the same as that rendered remotely 319.

In other examples, the system 10 enables remote rendering 319 of a reduced version of the first user ambient audio 32. That is the first user ambient audio 32 that is rendered locally 19 has content that is not present in what is rendered remotely 319.

The system 10 comprises:
means 20 for capturing ambient audio 30
means for applying an audio cancellation process 38 to the captured ambient audio 30 to create first user ambient audio information 36.

In some examples, the audio cancellation process 38 is the same as the audio cancellation process 34. This provides remote rendering 319 of the first user ambient audio 32. That is, the first user ambient audio 32 that is rendered locally 19 is the same as that rendered remotely 319.

In some examples, the audio cancellation process 38 is the different to the audio cancellation process 34. This provides first user ambient audio 32 that is rendered locally 19 that is different to what is rendered remotely 319.

For example, in some but not necessarily all examples, the first audio cancellation process 34 is configured to disambiguate audio sources in the captured ambient audio 30 and to apply different cancellation processes to audio of different audio sources.

This can be used to selectively remove audio sources from the captured ambient audio 30. For example, the audio source that represents a voice of a first user 2 of the system 10 can be removed from the captured ambient audio 30. For example, the audio source that represents a sudden noise can be removed from the captured ambient audio 30. For example, the audio source that represents a background noise, such as traffic noise, can be removed from the captured ambient audio 30.

This can be used to selectively maintain audio sources in the captured ambient audio 30. Thus there is audio pass-through (or audio transparency). For example, the audio source that represents a recognized voice, for example a voice of a family member, can be maintained in the captured ambient audio 30. For example, the audio source that represents a new voice can be maintained in the captured ambient audio 30. For example, audio sources that a first user has selected (explicitly or implicitly) can be maintained in the captured ambient audio 30.

The audio cancellation process 34 and audio cancellation process 38 can be configured to apply different cancellation processes to audio of different audio sources.

In some examples, a first audio cancellation process 34 is applied to the captured ambient audio 30 to create first user ambient audio 32 for rendering to a local user 2, and a second audio cancellation process 38 is applied to the captured ambient audio 30 to create remote user ambient audio for remote rendering 319 to a remote user 302.

The second audio cancellation process 38 is different to the first audio cancellation process 34 and is configured to cancel audio in addition to that cancelled by the first audio cancellation process 34.

For example, one or more audio sources that were selectively maintained in the captured ambient audio 30 during the first audio cancellation process 34 are removed in the second audio cancellation process 38.

For example, the audio source that represents a recognized voice, for example a voice of a family member, can be maintained in the captured ambient audio 30 by the first audio cancellation process 34 and removed by the second audio cancellation process 38.

For example, the audio source that represents a new voice can be maintained in the captured ambient audio 30 by the first audio cancellation process 34 and removed by the second audio cancellation process 38.

For example, audio sources that a first user has selected (explicitly or implicitly) as private can be maintained in the captured ambient audio 30 by the first audio cancellation process 34 and removed by the second audio cancellation process 38.

For example, audio sources that a first user has selected (explicitly or implicitly) as not-private can be maintained in the captured ambient audio 30 by the first audio cancellation process 34 and maintained by the second audio cancellation process 38.

In at least some examples, the first audio cancellation process 34 is prioritized over the second audio cancellation process 38. This can be used to avoid a delay in the first audio cancellation process 34. The prioritization can be by allocation of resources in parallel or by temporal ordering. In at least some examples, the second audio cancellation process 38 is performed after the first audio cancellation process 34.

In at least some examples, the first audio cancellation process 34 is specific to the form of local rendering 19 performed whereas the second audio cancellation process 38 is not specific to the form of local rendering 19 performed. In this example, the first user ambient audio 32 is configured specifically for immediate rendering using the specific rendering process of the system 10 whereas the first user ambient audio information 36 is configured for subsequent rendering using an as yet undetermined rendering process.

In some examples, the first user ambient audio information 36 comprises the first user ambient audio 32, or least some of the first user ambient audio 32, for example, in an audio encoded format.

Thus the first user ambient audio is produced and rendered locally from the captured ambient audio and a version of the first user ambient audio is transferred for remote rendering. In some examples, the first user ambient audio 32 that is rendered locally 19 is the same as that rendered remotely 319. In other examples, the first user ambient audio 32 that is rendered locally 19 has content that is not present in what is rendered remotely 319. That, there is remote rendering of a reduced version of the first user ambient audio 32.

In some examples, the first user ambient audio information 36 comprises captured ambient audio 30 (for example in an encoded format) and data to enable remote reproduction and remote rendering 319 of at least some of the first user ambient audio 32.

In some examples, the reproduction enables the first user ambient audio 32 that is rendered locally 19 to be the same as the first user ambient audio 32 that is rendered locally 19. In other examples, the reproduction enables the first user ambient audio 32 that is rendered locally 19 to be a reduced version of the first user ambient audio 32 that is rendered locally 19. That is the first user ambient audio 32 that is rendered locally 19 has content that is not present in what is rendered remotely 319. Thus the first user ambient audio is produced and rendered locally from the captured ambient audio and a version of the first user ambient audio is reproduced and rendered remotely from the captured ambient audio and the data.

In some examples, the data is dependent on the audio cancellation process 34 applied to the ambient audio to create first user ambient audio 32.

In some examples, the data is dependent on the audio cancellation process 38.

In some examples, the data is dependent on a level of ambient audio leak for the first audio cancellation process 34 that is applied to the captured ambient audio 30 to create the first user ambient audio 32.

In some examples, a comparison is performed between the captured ambient audio 30 and the first user ambient audio 32 to determine ambient leak.

In some examples, parameters from the first audio cancellation process 34 indicate ambient leak.

In FIGS. 1 and 2, the ambient audio is captured by one or more microphones 20 as captured ambient audio 30. Although the capturing of the ambient audio is illustrated separately in FIGS. 1 and 2, in at least some examples a single audio capture process can capture the ambient audio used in FIGS. 1 and 2. Thus the captured ambient audio 30 in FIGS. 1 and 2 can be the same.

A controller 700 can be used to perform the audio cancellation processes 34, 38.

In FIG. 2, a communication interface can be used to transfer the at least first user ambient audio information 36 and first user content information 42 to a remote apparatus 300 for remote rendering 318.

In FIG. 2, the content information 42 can be the content 40, for example in an encoded format, or can be information that identifies the content 40.

In at least some examples, the audio content 40 is spatial audio content and the content information 42 enables the rendering of the spatial audio content 40.

Spatial audio describes the rendering of sound sources at different controllable directions relative to a first user. The user can therefore hear the sound sources as if they are arriving from different directions. A spatial audio service controls or sets at least one directional property of at least one sound source. The directional properties are properties that can be defined independently for different directions and can for example include relative intensity of the sound source, size of the sound source, distance of the sound source, or audio characteristics of the sound source such as reverberation, spectral filtering etc.

Various audio formats can be used for spatial audio. Examples include multi-channel mixes (e.g., 5.1, 7.1+4), Ambisonics (FOA/HOA), parametric spatial audio (e.g., Metadata-assisted spatial audio—MASA, which has been proposed in context of 3GPP IVAS codec standardization), object-based audio, and any suitable combinations thereof.

In some examples, spatial audio is rendered to a first user via a head-mounted apparatus (a headset). The rendered sound sources can be positioned relative to the real-world or positioned relative to the headset.

Positioning of sound sources relative to the headset, does not require any tracking of movement of the headset.

Positioning of sound sources relative to the real-world does require tracking of movement of the headset. If a point of view defined for the headset rotates to the right, then the sound scene comprising the sound sources needs to rotate to the left so that it remains fixed in the real-world (world-fixed).

The point of view can be defined by orientation or by orientation and location. Where the point of view is defined by three-dimensional orientation it is described as 3DoF (three degrees of freedom). Where the point of view is defined by three-dimensional orientation and by three-dimensional location it is described as 6DoF (six degrees of freedom). Where the point of view is defined by three-dimensional orientation and by only limited movement such as leaning, it is described as 3DoF+(three degrees of freedom plus).

Thus, without head-tracking a sound scene remains fixed to the user's head when the user rotates their head, and with head-tracking the sound scene rotates relative to user's head, when user rotates their head, in a direction opposite to the user's head rotation so that sound sources appear fixed in space.

Not all audio services are spatial audio services. For example, an audio service can provide monophonic audio or stereo audio.

FIG. 3 illustrates an example of a system 10. In this example, the system comprises: an apparatus 12 and an apparatus 100.

In this example, the apparatus 12 is configured as a head-worn apparatus 12 that is worn by a first user 2. In this example, the apparatus 12 is configured as a head-worn apparatus 12, optionally an in-ear apparatus 12, an on-ear apparatus 12 or an over-ear apparatus 12.

In this example, the apparatus 100 is configured as a communication apparatus 100, local to the first user 2, which is used to provide a communication pathway 110 between the head-worn apparatus 12 and the remote apparatus 300. In this example, the communication pathway 110 is wireless.

The local apparatus 100 can in at least some examples provide additional processing resources not available in the head-worn apparatus 12.

In some examples, the head-worn apparatus 12 is configured to perform the first audio cancellation process 34 and the second audio cancellation process 38.

In some examples, the head-worn apparatus 12 is configured to perform the first audio cancellation process 34 and the local apparatus 100 is configured to perform the second audio cancellation process 38.

In some examples, the local apparatus 100 is configured to perform the first audio cancellation process 34 and the second audio cancellation process 38.

In this example, the apparatus 12 comprises means 14 for rendering 19, to a first user 2, first user ambient audio 32 and means 14 for rendering 19, to the first user 2, audio content 40.

The head-worn apparatus 12 comprise a left-ear part 14 and a right ear part 14. Each of the parts 14 comprises one or more speakers 18 associated with a cavity 16 formed between the first user's ear and audio isolation 15 which creates a sound barrier. The cavity 16 can be described as an interior cavity as it is an enclosed cavity formed between the apparatus 12 and the first user. The one or more speakers 18 are used for rendering 19 of audio in the interior cavity 16.

The head-worn apparatus 12 also comprises means 20 for capturing ambient audio 30 such as one or more exterior microphones on an exterior portion of the parts 14. The ambient audio is external to the head-worn apparatus 12. It is the noise in the environment external to the apparatus 12

Multiple exterior microphones can be used to capture spatial audio as an exterior sound scene comprising multiple spatially located sound sources.

In some examples, the head-worn apparatus 12 also comprises means for capturing audio within the cavity 16, such as interior microphones.

In some examples, the exterior microphones and/or the interior microphones can be used for active noise cancellation ANC.

Active noise cancellation (ANC) estimates the noise that would reach a listener's ear and adapts the audio output signals to cancel that estimated noise. The noise can be estimated using a feed-forward approach that uses one or more noise signals measured using one or more exterior microphones on the same ear device and/or using a feed-back approach that uses one or more noise signals measured using one or more interior microphones of the same ear device.

In some examples, the audio content 40 is spatial audio content configured for rendering via a left-ear part 14 and a right ear part. For example, the audio content 40 can be binaural encoded.

In some examples, the local apparatus 100 is configured to communicate 110 with the head-worn apparatus 12 via a radio transceiver, for example, a Bluetooth or WIFI transceiver.

In some examples, the local apparatus 100 is configured to communicate with the remote apparatus 300 either directly or indirectly via a network 200. In some examples, the local apparatus 100 comprises a radio transceiver, for example, a cellular or WIFI transceiver for such communication.

The local apparatus 100 can therefore comprise means for providing to another apparatus 300 at least first user ambient audio information 36; and first user content information 42 to enable remote rendering 319 of first user content and first user ambient audio 32 to a remote user.

In some examples, the local apparatus 100 comprises means 14 for rendering 19, to a first user 2, first user ambient audio 32 and audio content 40 such as one or more speakers.

In some examples, the local apparatus 100 comprises means for capturing ambient audio 30 such as one or more exterior microphones. Multiple exterior microphones can be used to capture an exterior sound scene comprising multiple spatially located sound sources.

FIG. 4 illustrates a method of local audio rendering 19 and also remote audio rendering 319.

Ambient audio 30 is captured by one or more microphones 20. The audio cancellation process 34 is applied to the captured ambient audio 30 to create first user ambient audio 32.

Audio content 40 is obtained 402, for example as local audio streams.

The audio content 40 and the first user ambient audio 32 are combined 405 and rendered locally 19 to the local user 2 via a head-worn apparatus 12 using speakers 18.

The combination of the audio content 40 and the first user ambient audio 32 is provided by the head-worn apparatus 12 to the local apparatus 100, where it is encoded 404 and transmitted 406 via network 200 to the remote apparatus 300 for reception 410, decoding 412 and remote rendering 319.

In this example, the remote apparatus 300 is a head-worn apparatus. However, in other examples it could be an arrangement of loudspeakers.

It will therefore be appreciated that the head-worn apparatus 12 comprises means for providing to another apparatus 100 at least first user ambient audio information 36 to enable remote rendering 319 of at least some of the first user ambient audio 32.

Also the local apparatus 100 comprises means 406 for providing to another apparatus 300 at least first user ambient audio information 36 to enable remote rendering 319 of at least some of the first user ambient audio 32.

In at least some examples, the format in which the first user ambient audio information 36 is provided to enable remote rendering 319 of the first user ambient audio 32 to the remote user, has one of more of the following characteristics:
the format enables remote rendering as world-fixed audio;
the format enables remote rendering at a headset or speakers, at choice of a rendering apparatus 12;
the format enables remote rendering as a sound source that has a particular location.

Rendering audio as world-fixed audio can be achieved using spatial audio processing which positions rendered sound sources at particular positions as previously described.

Spatial audio can be rendered using different spatial audio rendering apparatus. The rendering apparatus can, for example, convert the received format to a format directly usable by the rendering apparatus.

FIGS. 5 and 6 illustrate an extension of the system 10 illustrated in FIGS. 1 and 2 to enable two-way voice communication.

FIG. 5 illustrates an example of a system 10 for rendering audio to a local user 2 (not illustrated).

The system 10 comprises:
means 20 for capturing ambient audio 30;
means for applying an audio cancellation process 34 to the captured ambient audio 30 to create first user ambient audio 32;
means 18 for rendering 19 first user ambient audio 32
means 18 for rendering 19 first user content 40.
means 18 for rendering 19 voice audio 50 of the remote user 302.

FIG. 6 illustrates an example of the system 10 that is operable to cause rendering of audio to a remote user (not illustrated).

The system 10 comprises:
means for providing to a remote apparatus 300 at least first user ambient audio information 36, first user content information 42 and first user voice audio 62 to enable remote rendering 319 of first user content 40, first user voice audio 60 and at least some of the first user ambient audio 32.

Referring to FIG. 6, the system 10 comprises means for providing to the other apparatus 300 the voice audio 60 (captured for a first user 2 of the apparatus 12), the first user ambient audio information 36, and first user content information 42 to enable remote rendering 319, to the remote user 302, of the voice audio 60, the audio content 40 and at least some of the first user ambient audio 32.

The system 10 comprises means for applying a third audio cancellation process 64 to the captured voice audio 60 to produce processed voice audio 62.

The first audio cancellation process 34 can be prioritized (as previously described) over the third audio cancellation process 64. The third audio cancellation process 64 can, in at least some examples, be performed in the remote apparatus 300.

FIG. 7 illustrates an example of the system 10 in use.

The first user 2 is wearing a head-worn apparatus 12. In this example, the first user 2 is wearing in-ear buds.

The first user 2 is listening to audio content 40, which in this example is spatial audio content. In this example, the audio content 40 is provided to the head-worn apparatus 12 by the local apparatus 100.

The head-worn apparatus 12 is configured to render locally 19: first user ambient audio 32 and audio content 40.

The first user 2 is speaking into the local apparatus 100 which captures the voice audio 60 of the first user 2.

In this example, the head-worn apparatus 12 produces the first user ambient audio 32, and provides this to the local apparatus 100.

As illustrated in FIG. 8, the local apparatus 100 then provides to a remote apparatus 300 first user ambient audio information 36, first user content information 42 and the voice audio 60 of the local user 2 to enable remote rendering 319 of first user content 40, the voice audio 60 and at least some of the first user ambient audio 32.

As illustrated in FIG. 8, the remote apparatus 300 can send voice audio 60 for the remote user 302 to the local apparatus 100 which can then provide it to the head-worn apparatus 12 for rendering 19 to the first user 2.

As a consequence, the local user 2 and the remote user 302 can particulate in a two-way full duplex voice communication. In addition, the first user 2 can share with the remote user 302 the audio environment they are experiencing which is made up of currently rendered spatial audio content 40 and a portion of the captured ambient audio 30 the first user 2 can hear.

FIG. 9 illustrates a method of local audio rendering 19 and control of remote audio rendering 319.

Ambient audio 30 is captured by one or more microphones 20. The audio cancellation process 34 is applied to the captured ambient audio 30 to create first user ambient audio 32.

Audio content 40 is obtained 402, for example as local audio streams. The audio content 40 is spatial audio content and it is converted 502 into a virtual sound scene appropriate for the local rendering apparatus.

The appropriately converted audio content 40 and the first user ambient audio 32 are combined 405 and rendered locally 19.

The parameters of the audio cancellation process 34 are provided to the audio cancellation process 38. The audio cancellation process 38 operates on the captured ambient audio 30 to produce first user ambient audio information 36.

Voice audio 60 of the first user 2 is captured. Optionally, a third audio cancellation process 64 is performed on the local user's voice audio 60 to produce processed voice audio 62.

The processed voice audio 62 (or voice audio 60), the first user ambient audio information 36, and the first user content information 42 are combined 405, encoded 404, and transmitted 406 into network 200 to enable remote rendering 319 of the voice of the first user 2, the first user content 40 and at least some of the first user ambient audio 32.

FIG. 10 illustrates an example of a method 600 comprising:
at block 602, applying a first audio cancellation process 34 to captured ambient audio 30 to create first user ambient audio 32;
at block 604, providing to another apparatus 12 at least first user ambient audio information 36 to enable remote rendering of at least some of the first user ambient audio 32.

It will be appreciated from the foregoing, that there can be provided a system 10 comprising:
means 20 for capturing ambient audio 30
means for applying a first audio cancellation process 34 to the captured ambient audio 30 to create first user ambient audio 32;
means 18 for rendering 19, to a first user 2, first user ambient audio 32;
means 18 for rendering 19, to the first user 2, first user content 40
means for providing to a remote user 302
at least first user ambient audio information 36;
first user content information 42
to enable remote rendering 319 of first user content 40 and at least some of the first user ambient audio 32 32 to the remote user.

FIG. 11 illustrates an example of a controller 700 suitable for use in an apparatus 12, 100. Implementation of a controller 700 may be as controller circuitry. The controller 700 may be implemented in hardware alone, have certain aspects in software including firmware alone or can be a combination of hardware and software (including firmware).

As illustrated in FIG. 11 the controller 700 may be implemented using instructions that enable hardware functionality, for example, by using executable instructions of a computer program 706 in a general-purpose or special-purpose processor 702 that may be stored on a computer readable storage medium (disk, memory etc.) to be executed by such a processor 702.

The processor 702 is configured to read from and write to the memory 704. The processor 702 may also comprise an output interface via which data and/or commands are output by the processor 702 and an input interface via which data and/or commands are input to the processor 702.

The memory 704 stores a computer program 706 comprising computer program instructions (computer program code) that controls the operation of the apparatus 12, 100 when loaded into the processor 702. The computer program instructions, of the computer program 706, provide the logic and routines that enables the apparatus to perform the methods illustrated in the accompanying Figs. The processor 702 by reading the memory 704 is able to load and execute the computer program 706.

The apparatus 12, 100 comprises:
at least one processor 702; and
at least one memory 704 including computer program code
the at least one memory 704 and the computer program code configured to, with the at least one processor 702, cause the apparatus 12, 100 at least to perform:
applying a first audio cancellation process 34 to captured ambient audio 30 to create first user ambient audio 32;
providing to another apparatus 12
at least first user ambient audio information 36
to enable remote rendering of at least some of the first user ambient audio 32.

The apparatus 12, 100 comprises:
at least one processor 702; and
   at least one memory 704 including computer program code,
   the at least one memory storing instructions that, when executed by the at least one processor 702, cause the apparatus at least to:
applying a first audio cancellation process 34 to captured ambient audio 30 to create first user ambient audio 32;
providing to another apparatus 12 at least first user ambient audio information 36 to enable remote rendering of at least some of the first user ambient audio 32.

As illustrated in FIG. 12, the computer program 706 may arrive at the apparatus 12, 100 via any suitable delivery mechanism 708. The delivery mechanism 708 may be, for example, a machine readable medium, a computer-readable medium, a non-transitory computer-readable storage medium, a computer program product, a memory device, a record medium such as a Compact Disc Read-Only Memory (CD-ROM) or a Digital Versatile Disc (DVD) or a solid-state memory, an article of manufacture that comprises or tangibly embodies the computer program 706. The delivery mechanism may be a signal configured to reliably transfer the computer program 706. The apparatus 12, 100 may propagate or transmit the computer program 706 as a computer data signal.

Computer program instructions for causing an apparatus to perform at least the following or for performing at least the following:
applying a first audio cancellation process 34 to captured ambient audio 30 to create first user ambient audio 32; and
providing to another apparatus 12 at least first user ambient audio information 36 to enable remote rendering of at least some of the first user ambient audio 32.

The computer program instructions may be comprised in a computer program, a non-transitory computer readable medium, a computer program product, a machine readable medium. In some but not necessarily all examples, the computer program instructions may be distributed over more than one computer program.

Although the memory 704 is illustrated as a single component/circuitry it may be implemented as one or more separate components/circuitry some or all of which may be integrated/removable and/or may provide permanent/semi-permanent/dynamic/cached storage.

Although the processor 702 is illustrated as a single component/circuitry it may be implemented as one or more separate components/circuitry some or all of which may be integrated/removable. The processor 702 may be a single core or multi-core processor.

At least some of the various examples described relate to spatial audio capture, transmission, and presentation. In particular, to audio processing, such as noise cancellation, of various spatial audio components for conversational spatial audio experience sharing.

The target in this kind of experience can be
1) to transmit the first user's voice
2) to share both the real ambience the first user hears and any virtual spatial audio that is presented to the first user (obviously excluding any content that is intended as private).

To control the “mix” between the real-world ambience and the virtual spatial audio content, the first user needs to apply a passthrough/noise cancellation setting that works for them. This setting changes the captured spatial audio in a way that is not directly available to the receiving user.

Accordingly, there can be two instances of the captured audio ambience according to different but matched processing for the two users (transmitting/first user and receiving/second user). The processing can be done on two separate devices with different requirements for latency and processing power. For example, earbuds 12 capture ambient audio 30 using several microphones 20. The earbuds 12 then apply a first audio cancellation processing 34 (e.g., to remove noise according to first user's ANC/transparency settings) and play back this first user ambient audio 32 to the first user 2 via the headphones 102. This corresponds to the ambience component of what the first user hears. The second apparatus 100 or service obtains the original captured ambient audio 30 and parameters relating to the first audio cancellation processing 34. Based on this, a second audio cancellation processing 38 is done to match the first audio cancellation processing 34. For example, the first audio cancellation processing 34 is for two channels (L and R), and the second audio cancellation processes 38 can be for more channels or otherwise a more complex representation (e.g., 4 Ambisonics component channels for FOA or 2 transport audio channels and spatial metadata for MASA). The noise-matched spatial audio is transmitted to the remote user 302 and can be rendered according to their head rotation information. Thus, the remote user 302 will now hear the same ambience audio experience as the first user 2.

If this approach is not used, it is not possible to deliver a correct shared audio experience from a first user 2 to a remote user 302 in all cases. In particular, when noise reduction is applied for the first user 2, this is not correctly reproduced. Either the remote user 302 does not experience the same signal (noise reduction is skipped, noise can be disturbing) or the remote user loses the ability to independently apply their own head rotations in the scene (first user's head rotations rotate the scene for the remote user).

When the approach is used, it becomes possible to provide an optimal shared audio experience also in case there is noise cancellation in use (e.g., any kind of transparency mode). The noise reduction characteristics from the first apparatus 12 are matched to the outgoing spatial audio signal on the second apparatus 100 (or service). The remote user 302 who receives this noise-matched spatial audio ambience is now able to hear the correct audio experience according to their own head rotations. The desired experience is thus enabled.

At least some of the examples herein described relate to audio capture and audio processing (including noise cancellation) for transmission for conversational spatial audio experience sharing, when using at least two apparatuses 12, 100 for audio capture or audio processing. In typical cases, the at least two apparatuses are a smartphone 100 and headset/earbuds 12. However, embodiments can consider also, e.g., headset/earbuds connected directly to network edge, where some heavy processing can be done. For example, we can call this approach split capture processing.

FIG. 7 presents an example scenario, where a first user 2 is making a (spatial audio) call. User 2 is wearing earbuds 12 connected to a smartphone 100, which connects to a second, receiving, remote apparatus 300 of a remote user 302 via a network 200, e.g., 5G. The first user's environment is not entirely quiet, e.g., there are ambience sources 30 that can be directional, diffuse, or a combination of them. The background ambient audio 30 can in some cases be interesting, in other cases in can be pure noise. It is understood the first user 2 may apply at least some level of audio cancellation process 34 (e.g. ANC) on their earbuds 12 to cancel out some of the background ambient audio 30 (e.g., noise) in order to make it easier to hear the remote user 302 and/or other content 40. For example, first user 2 is simultaneously experiencing a spatial content stream 40, e.g., a music stream. In the example scenario, this spatial content stream 40 appears as a sound source to user's right-hand side. (For example, it can be considered as an audio object.)

The first user 2 may wish to transmit their spatial audio experience to the remote user 302. This experience includes the first user ambient audio 32 and the spatial content stream 40. In addition, first user's voice audio 50 is sent to allow for communications between the users 2, 302. Various audio capture and transmission techniques will need to be employed for optimal audio experience in this scenario, although the experience itself is simple and natural.

For example, various machine learning approaches can be used. There may not be sufficient computational power and/or battery on certain devices such as headsets or earbuds 12 to utilize some of the methods. For example, head-worn apparatuses 12 should generally not be too bulky, too heavy, or get too hot due to heavy processing load. On the other hand, it is also a significant cost issue to provide high computing power. Thus, computing-intensive processing capability is typically available, e.g., on a smartphone 100 but not on an accessory apparatus 12 such as earbuds.

Let us consider the first processing chain in FIG. 4. Considering the transmission part, i.e., what happens on first user's end, it is typically the case that a single apparatus is connected to the network 200, carrying out the transmission, audio encoding, and any scene processing (e.g., mixing or other stream combination functionalities). This apparatus 100 is, e.g., the smartphone. At least some of the audio capture and noise cancellation can happen at the earbuds 12.

It is desirable to have an optimal approach for creating and transmitting the spatial audio experience according to the technical limitations. In particular, we need to consider where and how noise cancellation happens.

Let us consider FIG. 4 in more detail.

There are at least two captured components:
User's ambient audio as rendered 32
User's voice audio 60

In addition, there can be at least one additional component relating to user's virtual spatial scene:
User's virtual scene stream(s) 40

User's captured ambient audio 30 is usually understood as the sounds surrounding the first user in the real-life environment. In terms of captured ambient audio 30, the ambience can include all the captured audio or that part 32 of the surrounding scene from which certain sources have been removed. For example, user's own voice audio 60 can be removed from the (spatial) audio capture resulting in ambience. However, in this case, we are not directly considering this ambience signal for transmission.

As we wish, in this example, to transmit the spatial audio experience of the first user 2, we consider what the first user 2 actually hears. The first user is wearing earbuds 12, and ideally the first user 2 only hears what the earbuds 12 present to the first user 2. Thus, in this case user's ambient audio refers to the spatial audio corresponding to user's surroundings that the earbuds present to the first user. For example, this component is thus the amount of audio transparency lets through.

User's voice audio 60 is the speech signal of the first user 2. In practice, we wish to transmit as clean voice as possible, i.e., we wish to suppress the background ambience (noise) from this signal using audio cancellation process 64, e.g., beamforming, noise suppression techniques, etc.

The first user's virtual scene streams refer to all the audio streams presented to first user 2 in addition to real ambience and signals transmitted by the other call participant (i.e. remote user 302). For example, user 2 can be listening to music and has placed a stream as an audio object on their right-hand side. A corresponding audio stream can be sent to the remote user 302 for them to experience the same spatial audio experience. Alternatively, metadata allowing the remote user's device 300 to retrieve this audio stream on its own can be sent in some examples. Note that signals originating from the remote user 302 are not sent back from first user 2 to remote user 302. For example, this includes the voice audio 50 of the remote user 302.

Thus, there can typically be at least two noise cancellation tasks for the captured audio. One is for the captured ambient audio 30 and the other one is for the voice signal 60. While low delay is preferable in all cases, only one of these tasks needs the lowest possible delay: the passthrough audio in the earbuds 12 corresponding to the first user's ambient audio (as experienced) 32 should be instant to not disturb the first user 2.

On the other hand, the audio cancellation process 34 for the first user's earbuds 12 and the transmission of the first user ambient audio 32 is a different task. In general, we do not wish to transmit a head-locked spatial audio to the remote user 302. We wish to allow for head-tracking of this audio presentation. On the other hand, the remote user 302 might also be experiencing the transmitted scene using a loudspeaker setup rather than headphones. Thus, full spatial audio transmission rather than fixed binaural transmission is desirable. Based on this, it becomes apparent that we should redo the audio cancellation process 34 performed by the ANC on the earbuds 12 for the spatial audio scene by performing a different audio cancellation process 38. In order to recreate the experience of the first user 2, this audio cancellation process 38 needs to have same properties (e.g., level) as what the earbuds' ANC has applied.

Let us consider FIG. 9.

According to this example, two audio cancellation processes 34, 38 are performed for the captured ambient audio 30. A first audio cancellation process 34 is the ANC on the earbuds 12. Parameters, e.g., level, of this operation are provided for a second audio cancellation process 38.

Alternatively, the earbuds 12 can transmit both the captured ambient audio signals 30 and the noise-cancelled first user ambient audio 32 to the second audio cancellation process 38 (allowing to obtain the desired parameters via analysis of the received signals 30, 32).

For example, this can be a machine learning-based audio cancellation process 38 on the more powerful apparatus 100 or service (e.g., smartphone, network edge). The earbuds 12 do not need to deliver the noise-cancelled audio anywhere (but they can, as explained for the alternative embodiment), this audio can be directly played back to the first user 2.

At least a spatial audio representation of the non-noise cancelled audio is sent to the main apparatus/service. There is typically also a third audio cancellation process 64 that relates to the captured voice audio 60. This can be carried out on the main apparatus 100 or service. In some examples, the third audio cancellation process 64 can also utilize the ‘parameters’ provided from the first noise cancellation 34 to the second audio cancellation process 38.

According to some examples, components are transmitted separately (voice+ambience, or voice+ambience+streams) or an audio mixing can simplify the scene before encoding and transmission. For example, the noise-cancelled spatial audio and local audio stream(s) could be downmixed into a single spatial audio representation (e.g., Metadata-Assisted Spatial Audio—MASA or First-Order Ambisonics—FOA). Typically, at least the voice audio 60, 62 would be sent separately to allow the remote user 302 to perform some scene manipulations, e.g., control the relative playback levels of at least voice and spatial scene.

FIG. 8 provides an example of the transmitted audio (and parameters). Instead of a smartphone, we can consider network edge server in some examples. Note that we can call the noise-cancelled spatial audio also, e.g., noise-matched spatial audio, since it has been applied a noise cancellation that depends on the noise-cancellation level used for the presentation for the first user. The experience is thus matched.

FIG. 8 also provides an example of the receiving user's experience.

Examples thus allow a remote user 302 to experience what the transmitting user 2 hears (ambience signals+any virtual streams) in addition to the transmitting user's voice. This experience includes the noise reduction processing that is done for the transmitting user. However, since this noise cancellation is done as quickly as possible (low latency) and therefore directly on a resource-constrained apparatus 12, headset/earbuds, it cannot always be as effective as noise cancellation that would otherwise be possible (and what can be done, e.g., for the outgoing voice signal). On the other hand, this noise cancellation is applied directly to the two signals that are played back as Left and Right signal to the transmitting user's ears. Since we wish to decouple the experience of the remote user 302 from that of the transmitting user 2 in terms of head rotations, we cannot use these signals directly. Instead we send a spatial audio (e.g., MASA or FOA) that is noise-matched with the direct headphone playback ambience component.

In embodiments, the audio transmission between the users 2, 302 can utilize separate streams for each of the components or a downmix of the streams. Separate streams can be preferable to allow the remote user 302 full manipulation of the spatial audio scene (e.g., moving the position of transmitting user's voice or increasing its volume), but a spatial downmix can be more efficient in terms of transmission bandwidth and rendering. Thus, both approaches are possible and the choice may depend, e.g., on the use case or system constraints.

The virtual scene streams (e.g., music stream) can be transmitted between users or information to retrieve the streams independently can be provided.

References to ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other processing circuitry. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ may refer to one or more or all of the following:
(a) hardware-only circuitry implementations (such as implementations in only analog and/or digital circuitry) and
(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory or memories that work together to cause an apparatus, such as a mobile phone or server, to perform various functions and (c) hardware circuit(s) and or processor(s), such as a microprocessor(s) or a portion of a microprocessor(s), that requires software (for example, firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

The blocks illustrated in the accompanying Figs may represent steps in a method and/or sections of code in the computer program 706. The illustration of a particular order to the blocks does not necessarily imply that there is a required or preferred order for the blocks and the order and arrangement of the block may be varied. Furthermore, it may be possible for some blocks to be omitted.

Where a structural feature has been described, it may be replaced by means for performing one or more of the functions of the structural feature whether that function or those functions are explicitly or implicitly described.

The systems, apparatus, methods and computer programs may use machine learning which can include statistical learning. Machine learning is a field of computer science that gives computers the ability to learn without being explicitly programmed. The computer learns from experience E with respect to some class of tasks T and performance measure P if its performance at tasks in T, as measured by P, improves with experience E. The computer can often learn from prior training data to make predictions on future data. Machine learning includes wholly or partially supervised learning and wholly or partially unsupervised learning. It may enable discrete outputs (for example classification, clustering) and continuous outputs (for example regression). Machine learning may for example be implemented using different approaches such as cost function minimization, artificial neural networks, support vector machines and Bayesian networks for example. Cost function minimization may, for example, be used in linear and polynomial regression and K-means clustering. Artificial neural networks, for example with one or more hidden layers, model complex relationship between input vectors and output vectors. Support vector machines may be used for supervised learning. A Bayesian network is a directed acyclic graph that represents the conditional independence of a number of random variables.

As used here ‘module’ refers to a unit or apparatus that excludes certain parts/components that would be added by an end manufacturer or a user.

The controller 700 can be a module.

The above-described examples find application as enabling components of: automotive systems; telecommunication systems; electronic systems including consumer electronic products; distributed computing systems; media systems for generating or rendering media content including audio, visual and audio visual content and mixed, mediated, virtual and/or augmented reality; personal systems including personal health systems or personal fitness systems; navigation systems; user interfaces also known as human machine interfaces; networks including cellular, non-cellular, and optical networks; ad-hoc networks; the internet; the internet of things; virtualized networks; and related software and services.

The apparatus can be provided in an electronic device, for example, a mobile terminal, according to an example of the present disclosure. It should be understood, however, that a mobile terminal is merely illustrative of an electronic device that would benefit from examples of implementations of the present disclosure and, therefore, should not be taken to limit the scope of the present disclosure to the same. While in certain implementation examples, the apparatus can be provided in a mobile terminal, other types of electronic devices, such as, but not limited to: mobile communication devices, hand portable electronic devices, wearable computing devices, portable digital assistants (PDAs), pagers, mobile computers, desktop computers, televisions, gaming devices, laptop computers, cameras, video recorders, GPS devices and other types of electronic systems, can readily employ examples of the present disclosure. Furthermore, devices can readily employ examples of the present disclosure regardless of their intent to provide mobility.

The term ‘comprise’ is used in this document with an inclusive not an exclusive meaning. That is any reference to X comprising Y indicates that X may comprise only one Y or may comprise more than one Y. If it is intended to use ‘comprise’ with an exclusive meaning then it will be made clear in the context by referring to “comprising only one . . . ” or by using “consisting”.

In this description, the wording ‘connect’, ‘couple’ and ‘communication’ and their derivatives mean operationally connected/coupled/in communication. It should be appreciated that any number or combination of intervening components can exist (including no intervening components), i.e., so as to provide direct or indirect connection/coupling/communication. Any such intervening components can include hardware and/or software components.

As used herein, the term “determine/determining” (and grammatical variants thereof) can include, not least: calculating, computing, processing, deriving, measuring, investigating, identifying, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

In this description, reference has been made to various examples. The description of features or functions in relation to an example indicates that those features or functions are present in that example. The use of the term ‘example’ or ‘for example’ or ‘can’ or ‘may’ in the text denotes, whether explicitly stated or not, that such features or functions are present in at least the described example, whether described as an example or not, and that they can be, but are not necessarily, present in some of or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class. It is therefore implicitly disclosed that a feature described with reference to one example but not with reference to another example, can where possible be used in that other example as part of a working combination but does not necessarily have to be used in that other example.

Although examples have been described in the preceding paragraphs with reference to various examples, it should be appreciated that modifications to the examples given can be made without departing from the scope of the claims.

Features described in the preceding description may be used in combinations other than the combinations explicitly described above.

Although functions have been described with reference to certain features, those functions may be performable by other features whether described or not.

Although features have been described with reference to certain examples, those features may also be present in other examples whether described or not.

The term ‘a’, ‘an’ or ‘the’ is used in this document with an inclusive not an exclusive meaning. That is any reference to X comprising a/an/the Y indicates that X may comprise only one Y or may comprise more than one Y unless the context clearly indicates the contrary. If it is intended to use ‘a’, ‘an’ or ‘the’ with an exclusive meaning then it will be made clear in the context. In some circumstances the use of ‘at least one’ or ‘one or more’ may be used to emphasis an inclusive meaning but the absence of these terms should not be taken to infer any exclusive meaning.

The presence of a feature (or combination of features) in a claim is a reference to that feature or (combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

The above description describes some examples of the present disclosure however those of ordinary skill in the art will be aware of possible alternative structures and method features which offer equivalent functionality to the specific examples of such structures and features described herein above and which for the sake of brevity and clarity have been omitted from the above description. Nonetheless, the above description should be read as implicitly including reference to such alternative structures and method features which provide equivalent functionality unless such alternative structures or method features are explicitly excluded in the above description of the examples of the present disclosure.

Whilst endeavoring in the foregoing specification to draw attention to those features believed to be of importance it should be understood that the Applicant may seek protection via the claims in respect of any patentable feature or combination of features hereinbefore referred to and/or shown in the drawings whether or not emphasis has been placed thereon.

I/We claim:

1-15. (canceled)

16. An apparatus comprising:
at least one processor; and
at least one memory storing instructions that, when executed by the at least one processor, cause the apparatus at least to:
apply at least a first audio cancellation process to captured ambient audio to create first user ambient audio;
provide to another apparatus at least first user ambient audio information to enable remote rendering of at least some of the first user ambient audio.

17. An apparatus as claimed in claim 16, wherein the application of the audio cancellation process to the captured ambient audio to create first user ambient audio is configured to:
disambiguate audio sources in the captured ambient audio; and
apply different cancellation processes to audio of different audio sources.

18. An apparatus as claimed in claim 16, wherein the first user ambient audio information comprises:
the captured ambient audio and data to enable remote reproduction and rendering of at least some of the first user ambient audio; or
the first user ambient audio.

19. An apparatus as claimed in claim 18, wherein the data is dependent on the audio cancellation process applied to the captured ambient audio to create the first user ambient audio.

20. An apparatus as claimed in claim 16, wherein the apparatus is further caused to apply a second audio cancellation process to the captured ambient audio to create remote user ambient audio for rendering to a remote user,
wherein the second audio cancellation process is different to a first audio cancellation process applied to the captured ambient audio to create the user ambient audio rendered to a first user and is configured to cancel audio in addition to that cancelled by the first audio cancellation process.

21. An apparatus as claimed in claim 20, configured to perform the second audio cancellation process after the first audio cancellation process.

22. An apparatus as claimed in claim 16, configured to provide to the another apparatus the at least first user ambient audio information in a format to enable remote rendering of the first user ambient audio to a remote user, wherein the format has one or more of the following characteristics:
enables remote rendering as world-fixed audio;
enables remote rendering at a headset or speakers, at choice of a rendering apparatus; or
enables remote rendering as a sound source that has a controlled location.

23. An apparatus as claimed in claim 16, wherein the apparatus is configured as at least one of a head-worn apparatus, an in-ear apparatus, an on-ear apparatus or an over-ear apparatus.

24. An apparatus as claimed in claim 16, wherein the apparatus is further caused to:
capture ambient audio;
render, to a first user, the first user ambient audio; and
render, to the first user, first user content.

25. An apparatus as claimed in claim 16, wherein the apparatus is further caused to provide to the another apparatus at least the first user ambient audio information and first user content information, to enable remote rendering of first user content and the first user ambient audio to a remote user.

26. Apparatus as claimed in claim 25, configured to communicate with a headset.

27. An apparatus as claimed in claim 16, wherein the apparatus is further caused to provide to the another apparatus voice audio, captured for a first user of the apparatus, to enable remote rendering of the voice audio and at least some of the first user ambient audio to a remote user.

28. A non-transitory computer readable medium comprising program instructions stored thereon for performing at least the following:
applying at least a first audio cancellation process to captured ambient audio to create first user ambient audio; and
providing to another apparatus at least first user ambient audio information to enable remote rendering of at least some of the first user ambient audio.

29. A method comprising:
applying at least a first audio cancellation process to captured ambient audio to create first user ambient audio; and
providing to another apparatus at least first user ambient audio information to enable remote rendering of at least some of the first user ambient audio.

30. A method as claimed in claim 29, wherein the application of the audio cancellation process to the captured ambient audio to create first user ambient audio is configured to:
disambiguate audio sources in the captured ambient audio; and
applying different cancellation processes to audio of different audio sources.

31. A method as claimed in claim 29, wherein the first user ambient audio information comprises:
the captured ambient audio and data to enable remote reproduction and rendering of at least some of the first user ambient audio; or
the first user ambient audio.

32. A method as claimed in claim 31, wherein the data is dependent on the audio cancellation process applied to the captured ambient audio to create the first user ambient audio.

33. A method as claimed in claim 29, further comprising:
applying a second audio cancellation process to the captured ambient audio to create remote user ambient audio for rendering to a remote user, wherein the second audio cancellation process is different to a first audio cancellation process applied to the captured ambient audio to create the user ambient audio rendered to a first user and is configured to cancel audio in addition to that cancelled by the first audio cancellation process.

34. A method as claimed in claim 33, wherein the second audio cancellation process is performed after the first audio cancellation process.

35. A method as claimed in claim 29, wherein the at least first user ambient audio information is provided to the another apparatus in a format to enable remote rendering of the first user ambient audio to a remote user, wherein the format has one or more of the following characteristics:
enables remote rendering as world-fixed audio;
enables remote rendering at a headset or speakers, at choice of a rendering apparatus; or
enables remote rendering as a sound source that has a controlled location.
